(19) United States
(12) Patent Application Publication
(10) Pub. No.: US 2026/0054900 A1
(43) Pub. Date: Feb. 26, 2026

(54) POLE CLIP

(71) Applicant: JAMESON, LLC, Clover, SC (US)

(72) Inventor: Blake Andrew Tomlinson, Statesville, NC (US)

(21) Appl. No.: 18/811,052

(22) Filed: Aug. 21, 2024

(51) Int. Cl. B65D 67/02; F16B 7/04

(52) U.S. Cl. CPC B65D 67/02; F16B 7/0433

(57) ABSTRACT

Devices include a pole clip device having a front surface, a back surface opposite the front surface, and a centralized hub. Lobes radially extend outwards from the centralized hub, the lobes including a proximal end coupled to the centralized hub and a distal end comprising arm(s) extending therefrom. The arm(s) form an arc along a tangential direction from the centralized hub on the distal end of each lobe of the lobes. The arm(s) of two adjacent lobes of the lobes form a semi-circle that includes an opening and the opening radially opens outward from the centralized hub. A front structural support material is positioned along an outer edge of the front surface of each of the lobes and a back structural support material is positioned along an outer edge of the back surface of each of the lobes.

### TECHNICAL FIELD

The present disclosure relates to pole clip devices, and more particularly pole clip devices for attaching to elongated cylindrical objects.

### BACKGROUND

In industries that utilize pole mounted tools, such as construction, maintenance, and various outdoor services, the use of pole mounted tools is essential for performing tasks that require extended reach. These tools often consist of multiple poles or segments that can be assembled to achieve the desired length. However, when not in use, these poles are typically separated into individual components for ease of storage and to accommodate transportation.

Despite this, transporting multiple separate poles can be cumbersome and inefficient. The poles can easily become disorganized or tangles, and traditional methods of securing them such as using straps, ropes, or carrying cases often prove to be time consuming, unreliable, or difficult to manage, particularly in challenging environments.

Professionals who frequently move between job sites require a more practical solution that allows them to bundle and secure these poles quickly and efficiently. The need is particularly acute in situations where time is of the essence, and ease of transportation directly impacts productivity. Moreover, secure bundling is crucial to prevent damage to the poles during transit and to minimize the risk of injury from shifting loads.

Therefore, improvements are needed in the transportation of pole mounted tools that minimize the laborious transportation and maneuvering of the pole mounted tools.

### SUMMARY

This summary is provided to briefly introduce concepts that are further described in the following detailed descriptions. This summary is not intended to identify key features or essential features of the claimed subject matter, nor is it to be construed as limiting the scope of the claimed subject matter.

In a first aspect, a pole clip device is disclosed herein. The pole clip device has a front surface and a back surface opposite the front surface. The pole clip device further comprises a centralized hub. The pole clip has at least two lobes radially extending outwards from the centralized hub. The at least two lobes have a proximal end coupled to the centralized hub and a distal end, where the distal end has at least one arm that forms an arc along a tangential direction from the centralized hub. Respective arms of two adjacent lobes of the at least two lobes together form a semi-circle that includes an opening, where the opening radially opens outward from the centralized hub. The pole clip device further comprises a front structural support material positioned along an outer edge of the front surface of each the at least two lobes and a back structural support material positioned along an outer edge of the back surface.

In some embodiments of the first aspect, the at least two lobes each have at least one opening configured to reduce the weight of the pole clip device. In these embodiments of the pole clip device, the pole clip device may also include a semi-flexible material and the at least one opening is configured to flex during insertion of an elongated cylindrical object into the opening such that the opening expands to conform to the shape of the elongated cylindrical object.

In some embodiments of the first aspect, the front and back structural support material has a varying thickness along the axial direction of the centralized hub. In these embodiments of the pole clip device, the varying thickness of the structural support material is largest at the proximal end of each the at least two lobes and smallest at the distal end of each the at least two lobes.

In some embodiments of the first aspect, the opening of the semi-circle formed by the adjacent lobes is smaller relative to the diameter of the semi-circle.

In some embodiments of the first aspect, the opening of the semi-circle has a latch configured to secure at least one elongated cylindrical object.

In some embodiments of the first aspect, an edge of the distal end of the at least two lobes are chamfered.

In some embodiments of the first aspect, the centralized hub has a centralized hub opening.

In a second aspect, a pole clip device is disclosed herein. The pole clip device has a front surface and a back surface opposite the front surface. The pole clip device further comprises a centralized hub. The pole clip has at least two lobes radially extending outwards from the centralized hub. The at least two lobes have a proximal end coupled to the centralized hub and a distal end opposite the proximal end that has at least one arm that forms an arc along a tangential direction from the centralized hub. Respective arms of two adjacent lobes of the at least two lobes together form a semi-circle that includes an opening. The opening radially opens outward from the centralized hub. The pole clip device further comprises a recessed channel located proximate to the distal end of each lobe of the at least two lobes.

In some embodiments of the second aspect, the pole clip device may also include a semi-flexible material and the at least one opening is configured to flex during insertion of an elongated cylindrical object into the opening such that the opening expands to conform to the shape of the elongated cylindrical object.

In some embodiments of the second aspect, the centralized hub has a centralized hub opening.

In some embodiments of the second aspect, the opening of the semi-circle formed by the adjacent lobes is smaller relative to the diameter of the semi-circle.

In some embodiments of the second aspect, the opening of the semi-circle has a latch configured to secure at least one elongated cylindrical object.

In some embodiments of the second aspect, the centralized hub has a smaller thickness than the at least two lobes.

In a third aspect, a pole clip device is disclosed herein. The pole clip device has a front surface and a back surface opposite the front surface. The pole clip device further comprises a centralized hub. The pole clip has three lobes radially extending outwards from the centralized hub. Each of the three lobes have a proximal end coupled to the centralized hub and a distal end opposite the proximal end. The distal end has two arms wherein the two arms form an arc along a tangential direction from the centralized hub. The first lobe has two long arms forming at least 30 degrees of the arc. The second lobe has a long arm forming at least 30 degrees of the arc and a short arm forming less than 30 degrees of the arc. The third lobe has two short arms forming less than 30 degrees of the arc.

In some embodiments of the third aspect, the pole clip device may also include a semi-flexible material and the at least one opening is configured to flex during insertion of an elongated cylindrical object into the opening such that the opening expands to conform to the shape of the elongated cylindrical object.

In some embodiments of the third aspect, the opening of the semi-circle formed by the adjacent lobes has a width that is smaller relative to the diameter of the semi-circle.

In some embodiments of the third aspect, the opening of the semi-circle has a latch configured to secure at least one elongated cylindrical object.

In some embodiments of the third aspect, the centralized hub has a centralized hub opening.

The above summary is to be understood as cumulative and inclusive. The above and below described features are to be understood as combined in whole or in part in various embodiments whether expressly described herein or implied by at least this reference. For brevity, not all features are expressly described and illustrated as combined with all other features. Various combinations of features shall be deemed supported whether or not appearing expressly in the drawings and descriptions.

### BRIEF DESCRIPTION OF THE DRAWINGS

The previous summary and the following detailed descriptions are to be read in view of the drawings, which illustrate some, but not all, embodiments and features as briefly described below. The summary and detailed descriptions, however, are not limited to only those embodiments and features explicitly illustrated.

FIG. 1 is a perspective front view of an embodiment of a pole clip.

FIG. 2 is a perspective back view of the embodiment of the pole clip of FIG. 1.

FIG. 3 is a front view of an embodiment of the pole clip of FIG. 1.

FIG. 4 is a back view of an embodiment of the pole clip of FIG. 1.

FIG. 5 is an example of an embodiment of the pole clip of FIG. 1 being used to clip together some pole-shaped tools.

FIG. 6 is a top view of an embodiment of the pole clip of FIG. 1.

FIG. 7 is a bottom view of an embodiment of the pole clip of FIG. 1.

FIG. 8 is a left-side view of an embodiment of the pole clip of FIG. 1.

FIG. 9 is a right-side view of an embodiment of the pole clip of FIG. 1.

FIG. 10 is a perspective front view of an embodiment of a pole clip.

FIG. 11 is a perspective back view of an embodiment of the pole clip of FIG. 10.

FIG. 12 is a front view of an embodiment of the pole clip of FIG. 10.

FIG. 13 is a back view of an embodiment of the pole clip of FIG. 10.

FIG. 14 is an example of an embodiment of the pole clip of FIG. 10 being used to clip together some pole-shaped tools.

FIG. 15 is a left-side view of an embodiment of the pole clip of FIG. 10.

FIG. 16 is a right-side of an embodiment of the pole clip of FIG. 10.

FIG. 17 is a top view of an embodiment of the pole clip of FIG. 10.

FIG. 18 is a bottom view of an embodiment of the pole clip of FIG. 10.

FIG. 19 is a perspective front view of an embodiment of a pole clip.

FIG. 20 is a perspective back view of an embodiment of the pole clip of FIG. 19.

FIG. 21 is a front view of an embodiment of the pole clip of FIG. 19.

FIG. 22 is a back view of an embodiment of the pole clip of FIG. 19.

FIG. 23 is an example of an embodiment of the pole clip of FIG. 19 being used to clip together some pole-shaped tools.

FIG. 24 is a left-side view of an embodiment of the pole clip of FIG. 19.

FIG. 25 is a right-side view of an embodiment of the pole clip of FIG. 19.

FIG. 26 is a top view of an embodiment of the pole clip of FIG. 19.

FIG. 27 is a bottom view of an embodiment of the pole clip of FIG. 19.

FIG. 28 is a perspective front view of an embodiment of a pole clip.

FIG. 29 is a perspective back view of an embodiment of the pole clip of FIG. 28.

FIG. 30 is a front view of an embodiment of the pole clip of FIG. 28.

FIG. 31 is a back view of an embodiment of the pole clip of FIG. 28.

FIG. 32 is an example of an embodiment of the pole clip of FIG. 28 being used to clip together some pole shaped tools.

FIG. 33 is a left-side view of an embodiment of the pole clip of FIG. 28.

FIG. 34 is a right-side of an embodiment of the pole clip of FIG. 28.

FIG. 35 is a top view of an embodiment of the pole clip of FIG. 28.

FIG. 36 is a bottom view of an embodiment of the pole clip of FIG. 28.

### DETAILED DESCRIPTIONS

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although steps may be expressly described or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

Like reference numbers used throughout the drawings depict like or similar elements. Unless described or implied as exclusive alternatives, features throughout the drawings and descriptions should be taken as cumulative, such that features expressly associated with some particular embodiments can be combined with other embodiments.

Unless defined otherwise, technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete and will fully convey the scope of the invention and enable one of ordinary skill in the art to make, use, and practice the invention.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

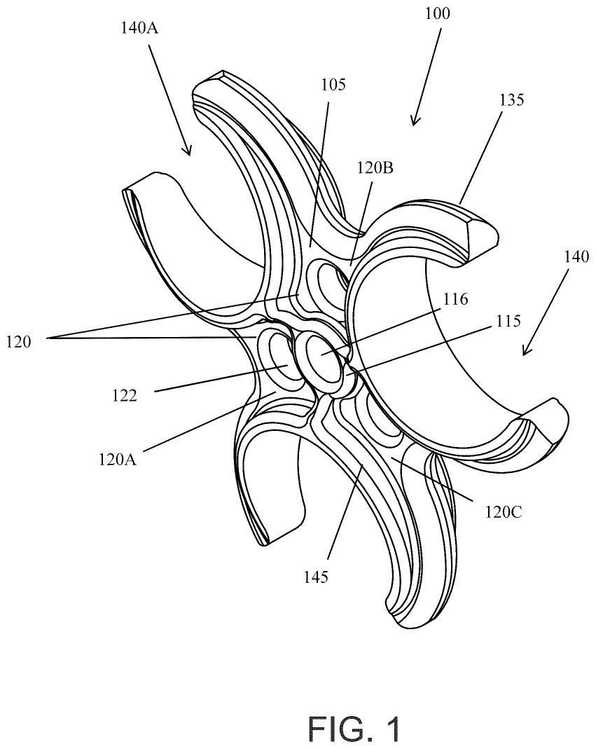

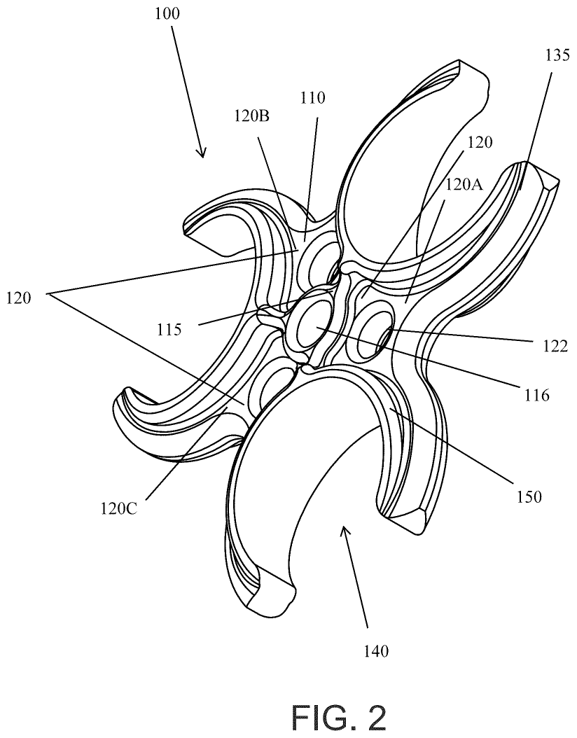

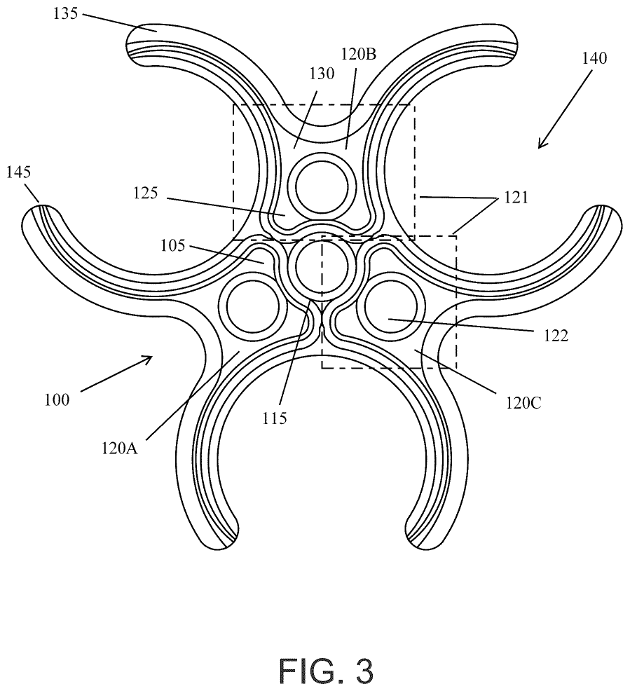

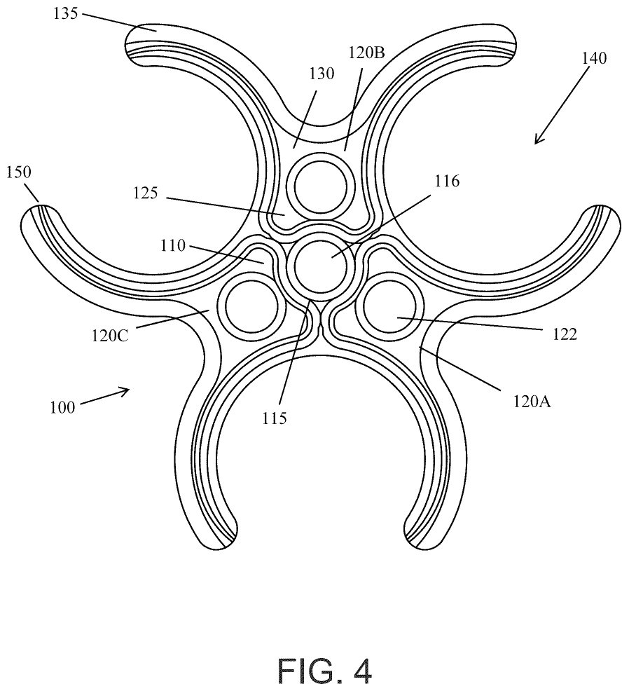

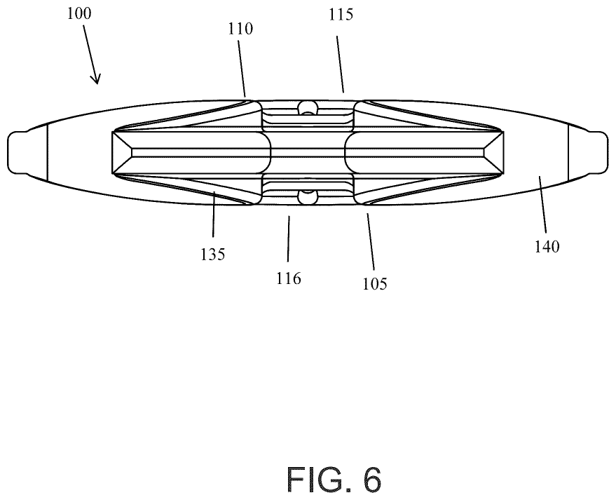

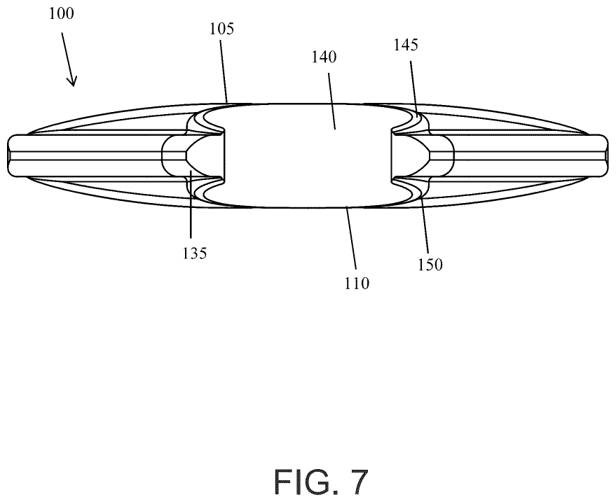

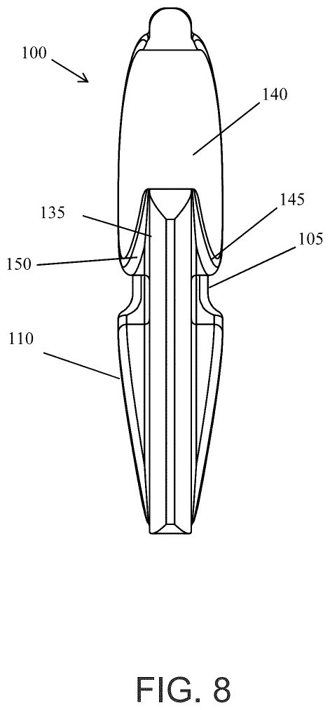

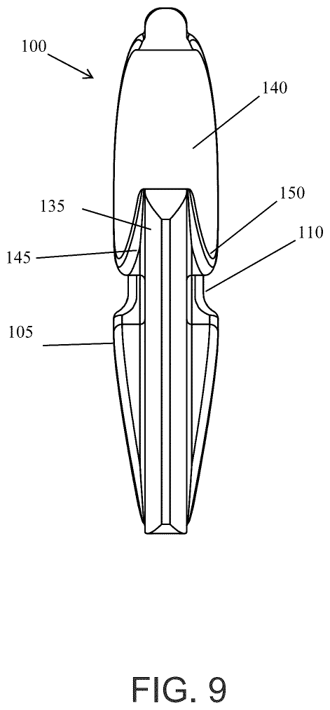

Referring to FIGS. 1-9, the pole clip device 100 includes a front surface 105 and a back surface 110 opposite the front surface 105. The pole clip device 100 further comprises a centralized hub 115. The pole clip device 100 includes at least two lobes 120 comprising a proximal end 125 of the at least two lobes coupled to the centralized hub 115. To ensure clarity when describing directions, a coordinate system is introduced wherein the z-axis will be hereafter referred to as the axial axis, centered at the centralized hub 115 and extending perpendicularly upwards from the front surface 105, and multiple radial axis defined as any direction perpendicular to axial axis and extending outwards along the at least two lobes 120. A tangential direction is defined as perpendicular to the radial axis at a distal end 130 of the at least two lobes 120. In the embodiment shown in FIGS. 1-9, the pole clip device 100 features three lobes 120A, 120B, 120C, two of which (120B and 120C) are highlighted with a dashed bounding box 121 in FIG. 3. Each of the at least two lobes 120 further comprises the distal end 130 wherein at least one arm 135 forms an arc along a tangential direction from the centralized hub 115 on the distal end 130 of each the at least two lobes 120. The at least one arm 135 of two adjacent lobes of the at least two lobes 120 form a semi-circle that includes an opening 140. The opening 140 radially opens outward from the centralized hub 115. The pole clip device 100 includes a front structural support material 145 along an outer edge of the front surface 105 of each the at least two lobes 120. The pole clip device 100 also includes a back structural support material 150 along an outer edge of the back surface 110 of each the at least two lobes 120.

The at least two lobes 120 may each have at least one opening 122 configured to reduce the weight of the pole clip device 100. The at least one opening 122 can take any shape and size depending on the ornamental design of the pole clip device 100 embodiment. For example, in some embodiments, the at least one opening 122 is circular, as depicted in FIGS. 1-9, and in other embodiments the at least one opening is a stadium shape, a triangular shape, a hexagonal shape, and/or rectangular shape.

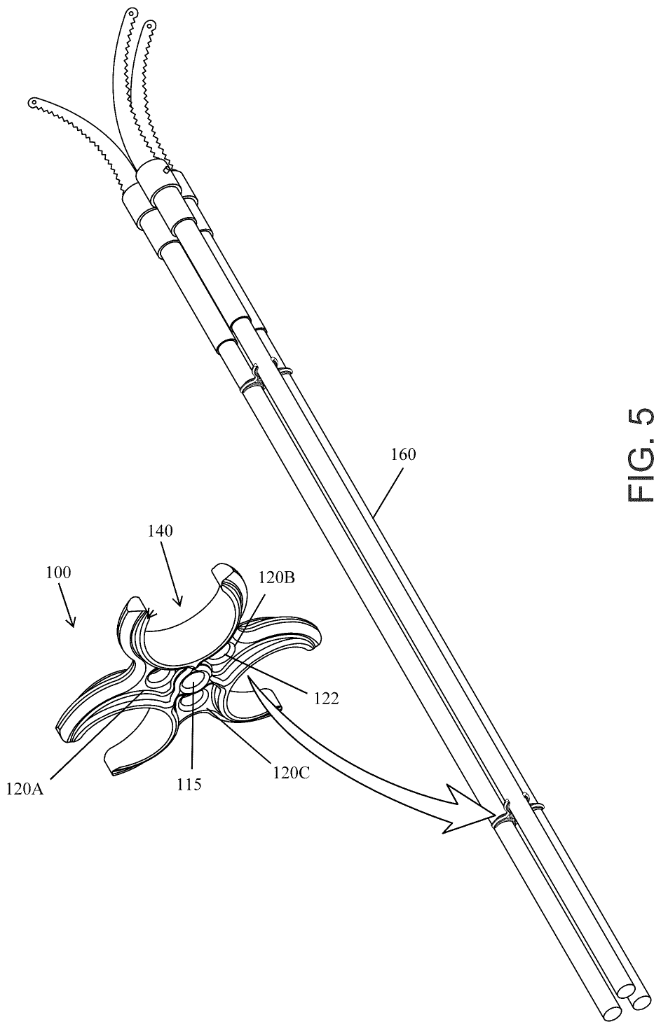

The pole clip device 100 may include a semi-flexible and/or semi-rigid material (e.g., in some instances, as a non-limiting example, part of the pole clip device 100 may be made of entirely of semi-flexible material, in other instances only the lobes 120 and/or the arms 135 are made of the semi-flexible material whereas the centralized hub 115 may be made of a semi-rigid material) and the at least one opening 140 formed by the at least one arm 135 of two adjacent lobes of the at least two lobes 120 is configured to flex during insertion of an elongated cylindrical object 160 into the opening 140 such that the opening 140 expands to conform to the shape of the elongated cylindrical object 160. Non-limiting examples of a semi-flexible material are: rubber, aluminum, and most plastics (e.g., low density polyethylene, high-density polyethylene, polypropylene, polybutylene adipate terephthalate, and/or combinations thereof). An example of the process of inserting the elongated cylindrical object 160 into the pole clip device 100 is illustrated in FIG. 5. In this example, the elongated cylindrical object 160 is a pruning tool but the cylindrical object 160 could also be other cylindrical shaped objects such as brooms, mops, rakes, etc. The opening 140 can be sized and shaped or otherwise configured to fit various other elongated objects whether such objects are fully cylindrical, semi-cylindrical, or otherwise sized and shaped to fit within the opening 140.

The front structural support material 145 and the back structural support material 150 may have varying thickness along the axial direction of the centralized hub 115. In FIGS. 1-9, the thickness is largest at the proximal end 125 of each the at least two lobes 120 and gradually tapers such that it is smallest at the distal end 130 of each the at least two lobes 120.

The opening 140 of the semi-circle formed by the adjacent lobes (e.g., see opening 140A positioned between lobe 120A and lobe 120B of FIG. 1) is smaller relative to the diameter of the semi-circle. The opening 140 of the semi-circle may feature a latch mechanism (e.g., such as a bolt latch, a spring latch, and/or a swinging latch) that is configured to secure an elongated cylindrical object 160.

The pole clip device 100 can also include finishing features to improve performance and aesthetic aspects of the device. Specifically, an edge of the distal end 130 of the lobes 120 could be chamfered to provide both aesthetic appeal and to provide a functional advantage so that it is smoother to grip and maneuver. Additionally, the centralized hub 115 can have a centralized hub opening 116.

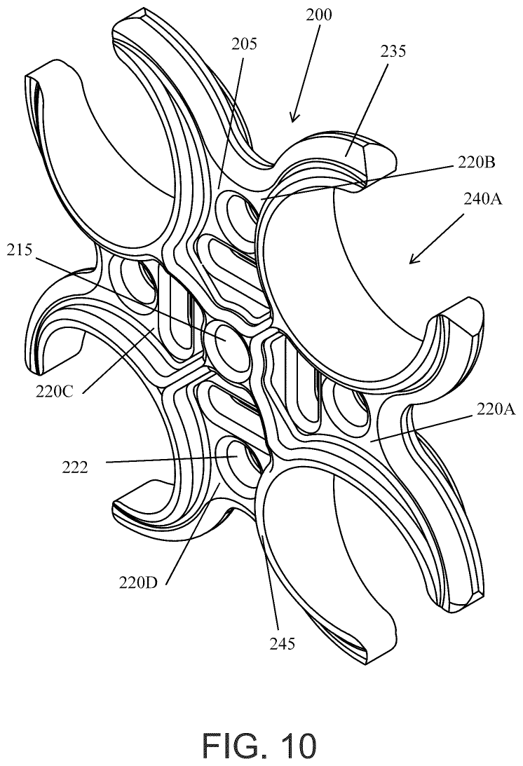

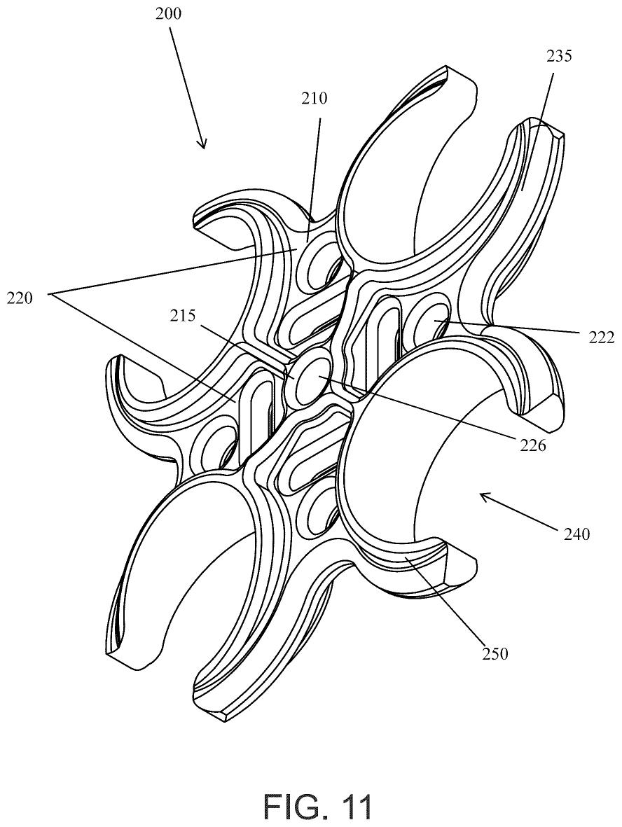

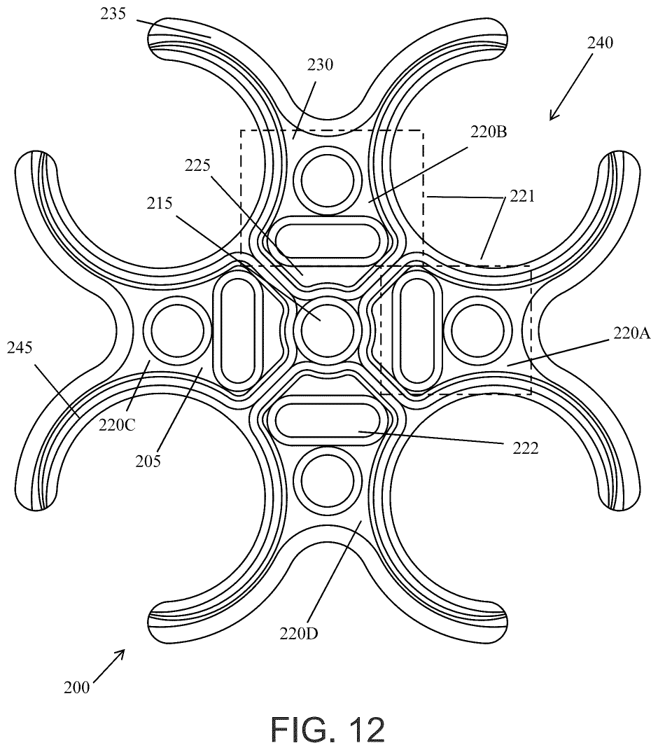

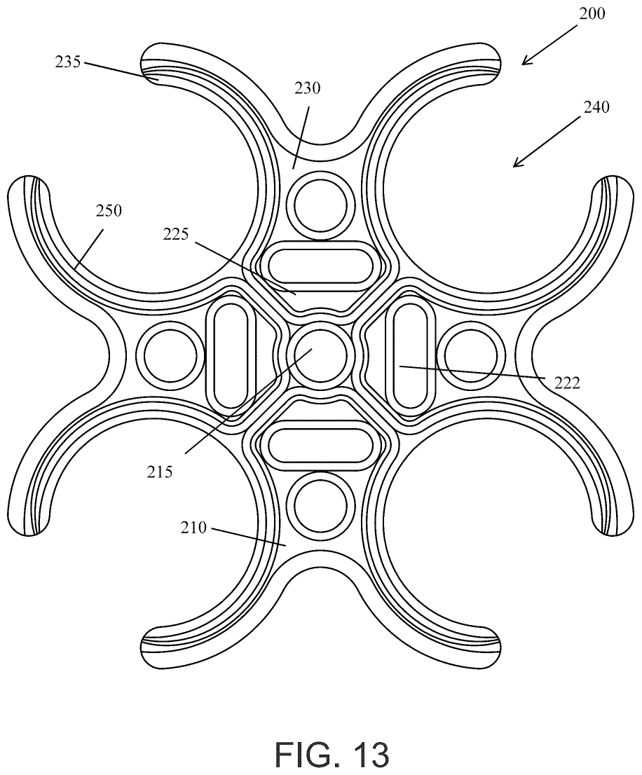

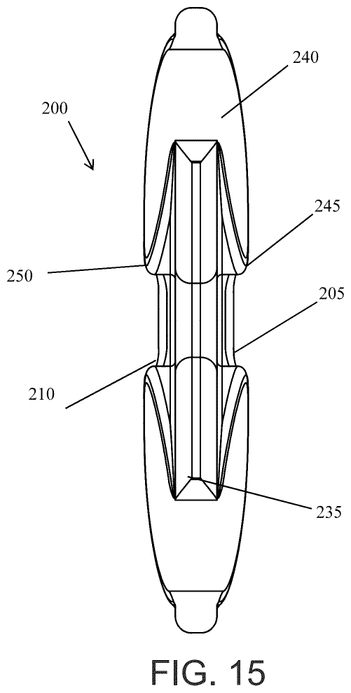

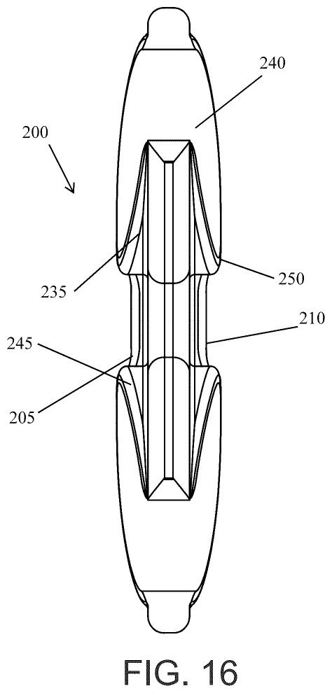

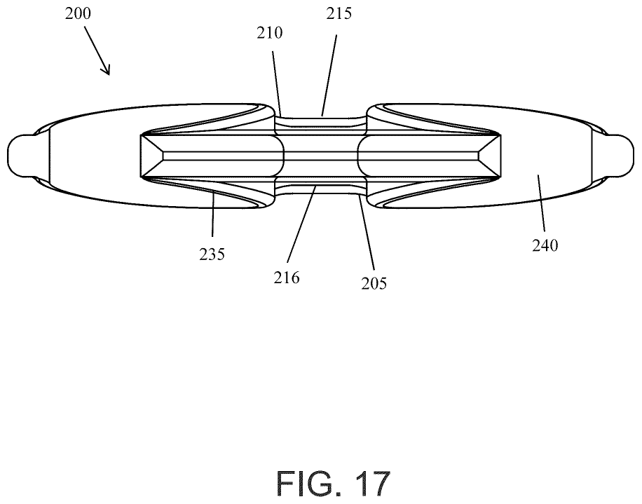

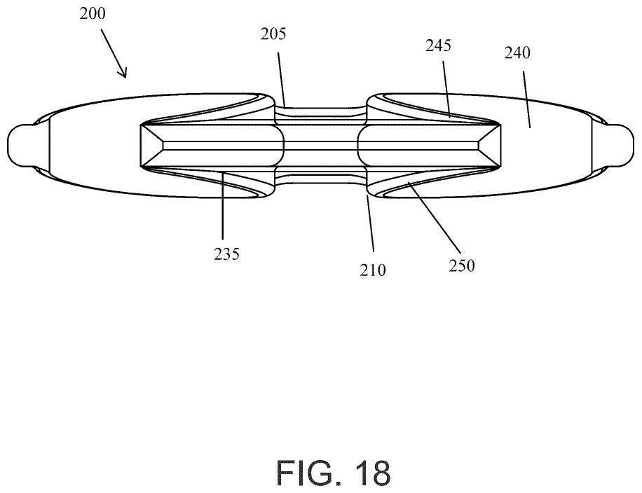

Referring to FIGS. 10-18, the pole clip device 200 includes a front surface 205 and a back surface 210 opposite the front surface 205. The pole clip device 200 further comprises a centralized hub 215. In some embodiments, the centralized hub 215 may include an aperture or may otherwise be hollow to minimize use of material during manufacture and to lessen the total weight of the pole clip device 200. The pole clip device 200 includes at least two lobes 220 comprising a proximal end 225 of the at least two lobes coupled to the centralized hub 215. To ensure clarity when describing directions, a coordinate system is introduced wherein the z-axis will be hereafter referred to as the axial axis, centered at the centralized hub 215 and extending perpendicularly upwards from the front surface 205, and multiple radial axis defined as any direction perpendicular to axial axis and extending outwards along the at least two lobes 220. A tangential direction is defined as perpendicular to the radial axis at a distal end 230 of the at least two lobes 220. In the embodiment shown in FIGS. 10-18, the pole clip device 200 features four lobes, two of which (220A and 220B) highlighted with a dashed bounding box 221 in FIG. 12. The at least two lobes 220 further comprises the distal end 230 wherein at least one arm 235 forms an arc along a tangential direction from the centralized hub 215 on the distal end 230 of each the at least two lobes 220. The at least one arm 235 of two adjacent lobes of the at least two lobes 220 form a semi-circle that includes an opening 240. The opening 240 radially opens outward from the centralized hub 215. The pole clip device 200 includes a front structural support material 245 along an outer edge of the front surface 205 of each the at least two lobes 220. The pole clip device 200 also includes a back structural support material 250 along an outer edge of the back surface 210 of each the at least two lobes 220.

The at least two lobes 220 may each have at least one opening 222 configured to reduce the weight of the pole clip device 200. The at least one opening 222 can take any shape and size depending on the ornamental design of the pole clip device 200 embodiment.

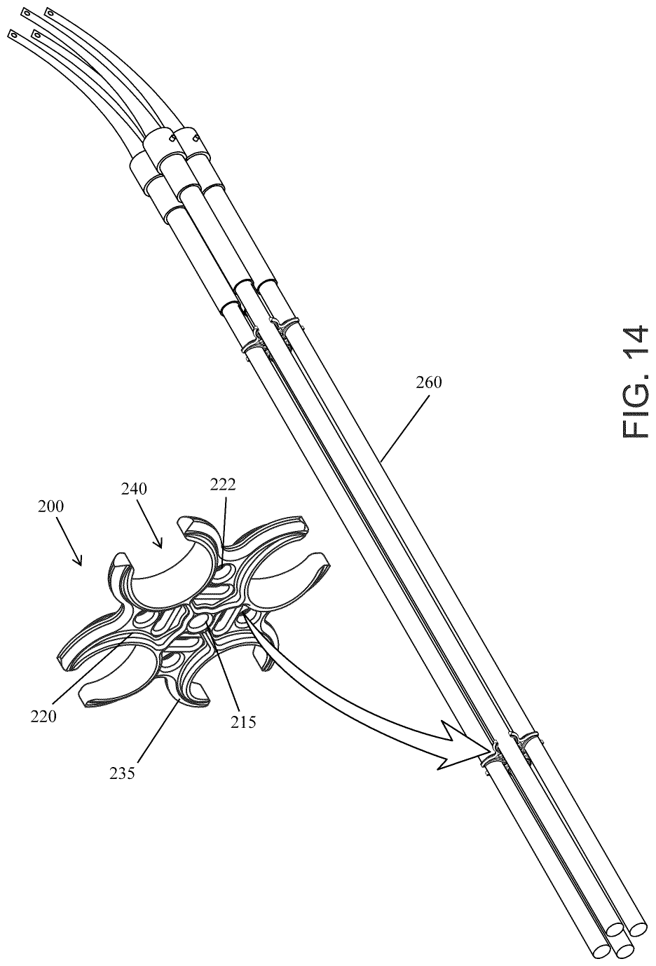

The pole clip device 200 may include a semi-flexible material and the at least one opening 240 formed by the at least one arm 235 of two adjacent lobes (e.g., such as lobe 220A and 220B of FIG. 10) of the at least two lobes 220 is configured to flex during insertion of an elongated cylindrical object 260 into the opening 240 such that the opening 240 expands to conform to the shape of the elongated cylindrical object 260. Non-limiting examples of a semi-flexible material are: rubber, aluminum, and most plastics (e.g., low density polyethylene, high-density polyethylene, polypropylene, polybutylene adipate terephthalate, and/or combinations thereof). An example of the process of inserting the elongated cylindrical object 260 into the pole clip device 200 is illustrated in FIG. 14. In this example, the elongated cylindrical object 260 is a pruning tool but the pole clip device 200 could also be other cylindrical shaped objects such as brooms, mops, rakes, etc. The opening 240 can be sized and shaped or otherwise configured to fit various other elongated objects whether such objects are fully cylindrical, semi-cylindrical, or otherwise sized and shaped to fit within the opening 240.

The front structural support material 245 and the back structural support material 250 may have varying thickness along the axial direction of the centralized hub 215. In FIGS. 10-18, the thickness is largest at the proximal end 225 of each the at least two lobes and smallest at the distal end 230 of each the at least two lobes.

The opening 240 of the semi-circle (e.g., see opening 240A positioned between lobe 220A and lobe 220B of FIG. 10) formed by the adjacent lobes is smaller relative to the diameter of the semi-circle. The opening 240 of the semi-circle may feature a latch mechanism (e.g., such as a bolt latch, a spring latch, and/or a swinging latch) configured to secure an elongated cylindrical object 260.

The pole clip device 200 can also include finishing features to improve performance and aesthetic aspects of the device. Specifically, an edge of the distal end 230 of the lobes 220 could be chamfered. Additionally, the centralized hub 215 can have a centralized hub opening 216.

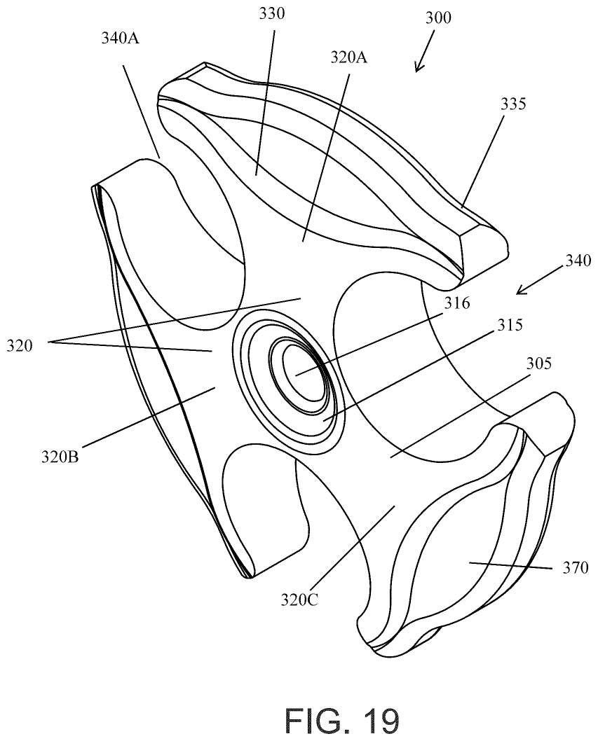

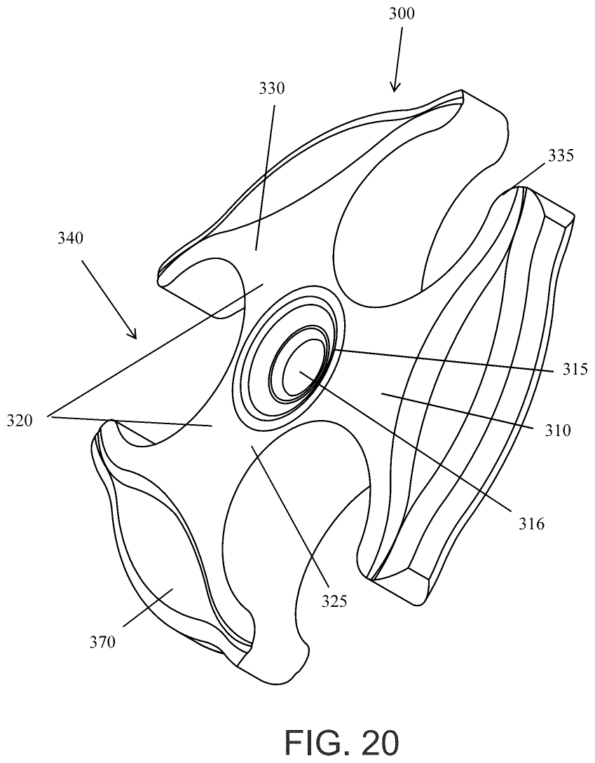

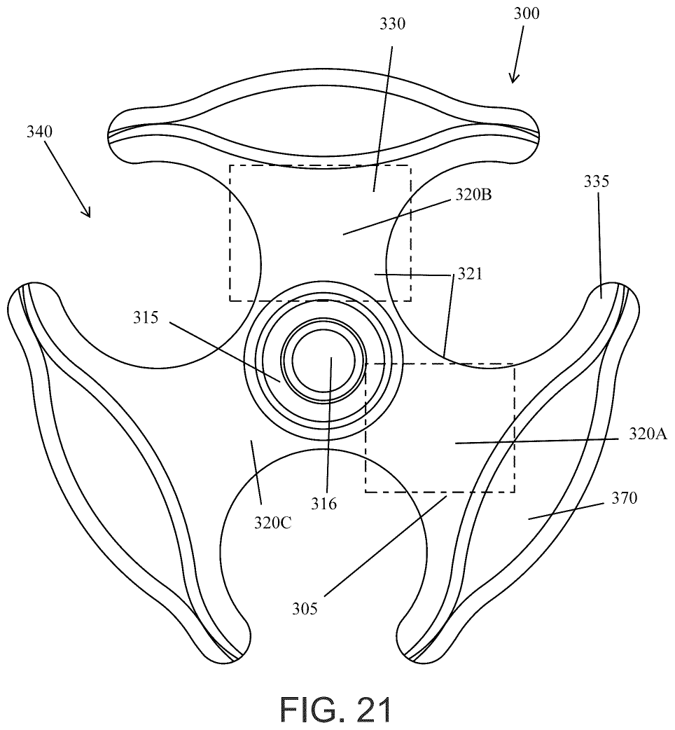

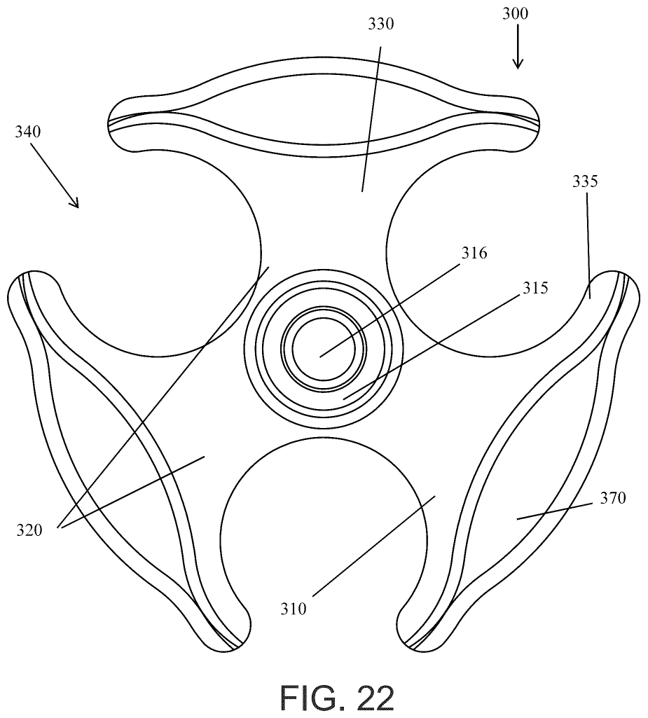

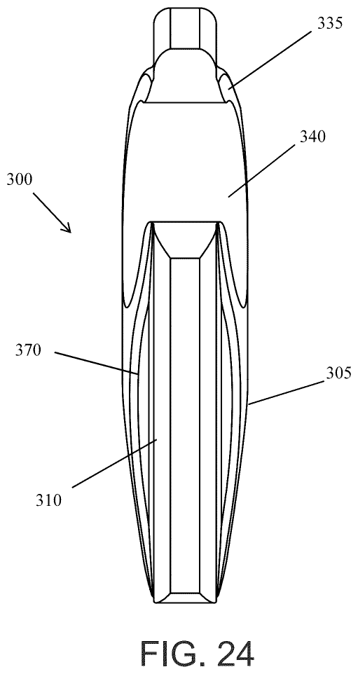

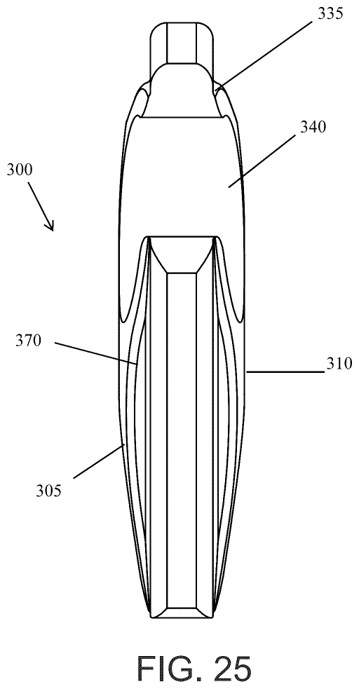

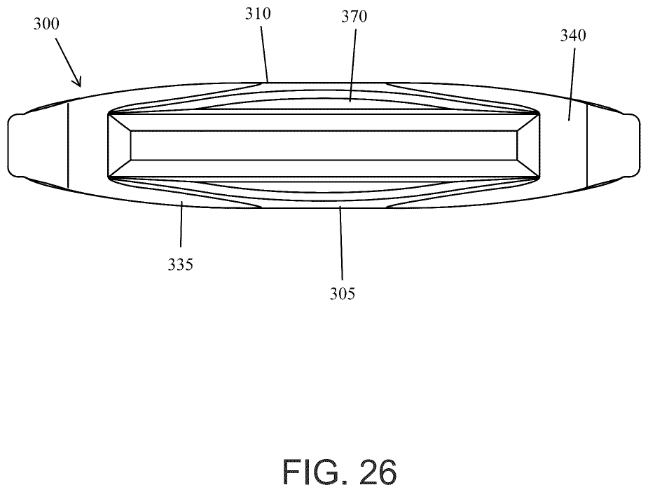

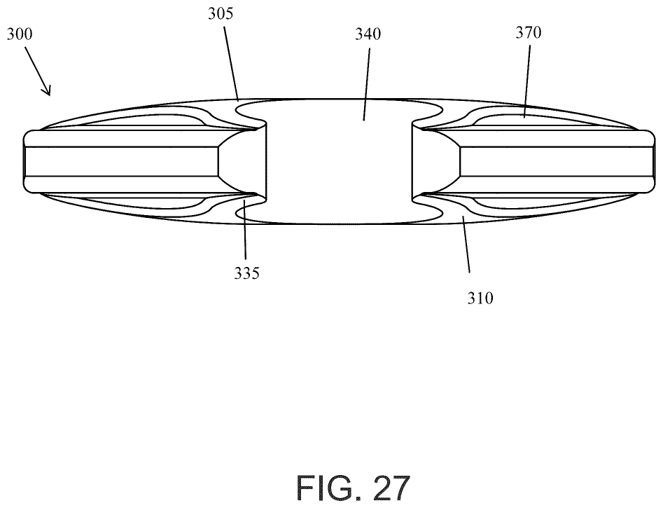

Referring to FIGS. 19-27, the pole clip device 300 includes a front surface 305 and a back surface 310 opposite the front surface 305. The pole clip device 300 further comprises a centralized hub 315. The pole clip device 300 includes at least two lobes 320 comprising a proximal end 325 of the at least two lobes coupled to the centralized hub 315. To ensure clarity when describing directions, a coordinate system is introduced wherein the z-axis will be hereafter referred to as the axial axis, centered at the centralized hub 315 and extending perpendicularly upwards from the front surface 305, and multiple radial axis defined as any direction perpendicular to axial axis and extending outwards along the at least two lobes 320. A tangential direction is defined as perpendicular to the radial axis at a distal end 330 of the at least two lobes 320. In the embodiment shown in FIGS. 19-27, the pole clip device 300 features three lobes, two of which (320A and 320B) highlighted with a dashed bounding box 321. The at least two lobes 320 further comprises the distal end 330 wherein at least one arm 335 forms an arc along a tangential direction from the centralized hub 315 on the distal end 330 of each the at least two lobes 320. The at least one arm 335 of two adjacent lobes of the at least two lobes 320 form a semi-circle that includes an opening 340. The opening 340 radially opens outward from the centralized hub 315.

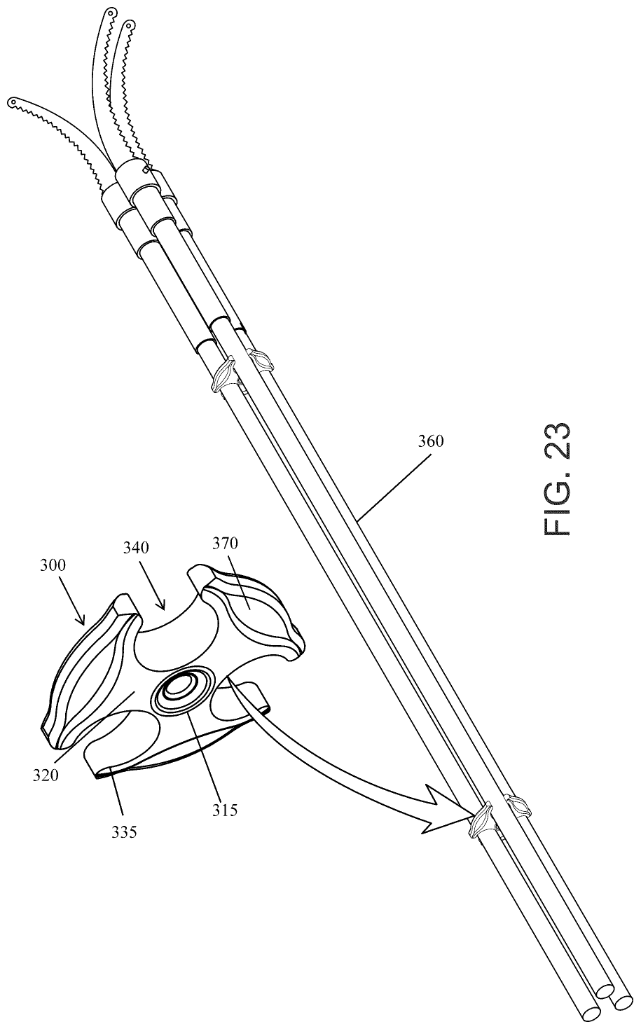

The pole clip device 300 may include a semi-flexible material and the at least one opening 340 formed by the at least one arm 335 of two adjacent lobes of the at least two lobes 320 is configured to flex during insertion of an elongated cylindrical object 360 into the opening 340 such that the opening 340 expands to conform to the shape of the elongated cylindrical object 360. Non-limiting examples of a semi-flexible material are: rubber, aluminum, and most plastics. An example of the process of inserting the elongated cylindrical object 360 into the pole clip device 300 is illustrated in FIG. 23. In this example, the elongated cylindrical object 360 is a pruning tool but the pole clip device 300 could also be other cylindrical shaped objects such as brooms, mops, rakes, etc. The opening 340 can be sized and shaped or otherwise configured to fit various other elongated objects whether such objects are fully cylindrical, semi-cylindrical, or otherwise sized and shaped to fit within the opening 340.

The opening 340 of the semi-circle formed by the adjacent lobes (e.g., such as lobe 320A and 320B of FIG. 19) is smaller relative to the diameter of the semi-circle. The opening 340 of the semi-circle may feature a latch mechanism (e.g., such as a bolt latch, a spring latch, and/or a swinging latch) configured to secure an elongated cylindrical object 360.

The pole clip device 300 can also include finishing features to improve performance and aesthetic aspects of the device. Specifically, a recessed channel 370 may be present proximate the distal end 330 of the lobes 320. This is an example of an aesthetic design choice. Additionally, the centralized hub 315 can have a smaller thickness relative to the at least two lobes 320. The centralized hub 315 can also feature a centralized hub opening 316.

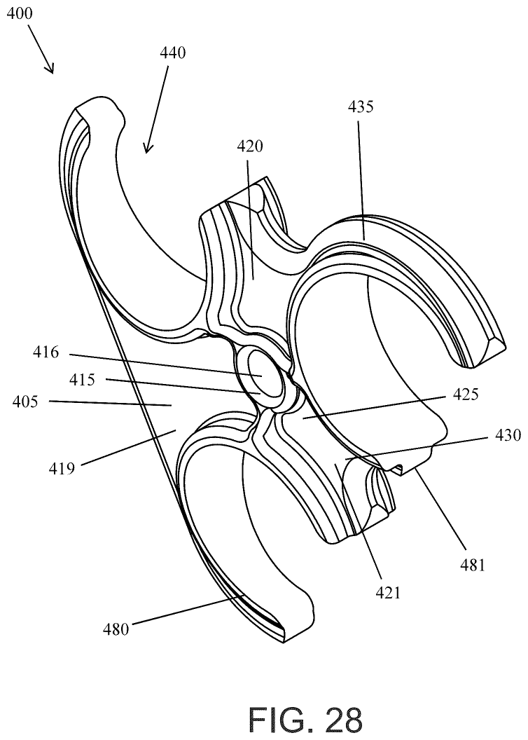

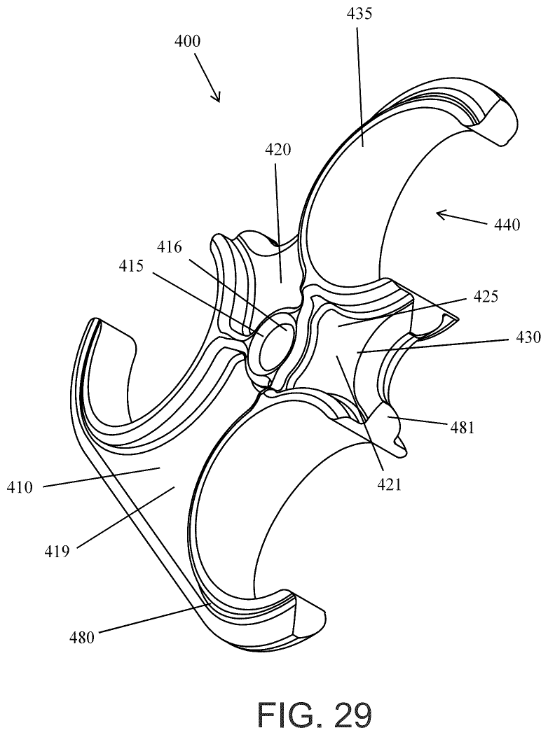

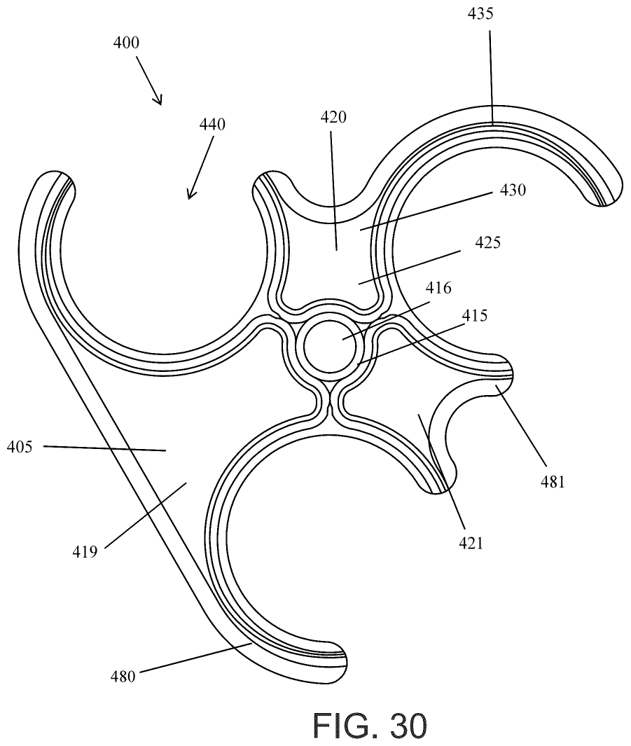

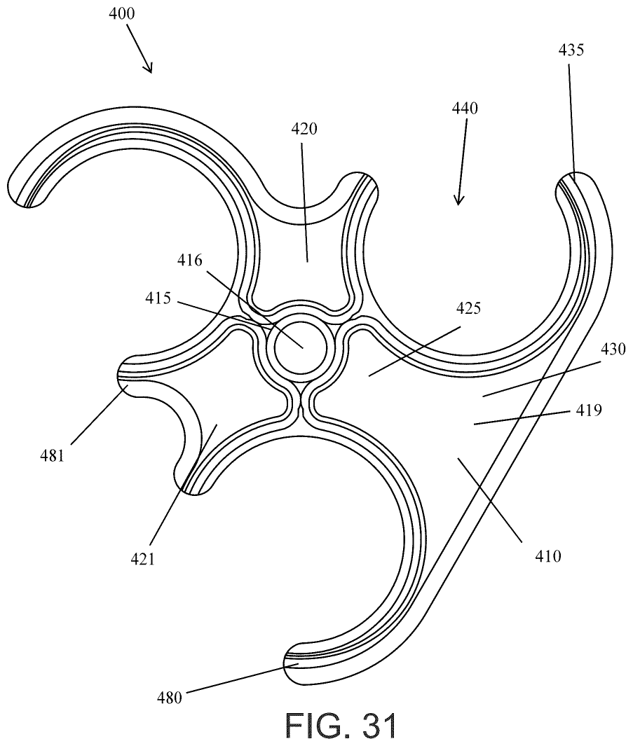

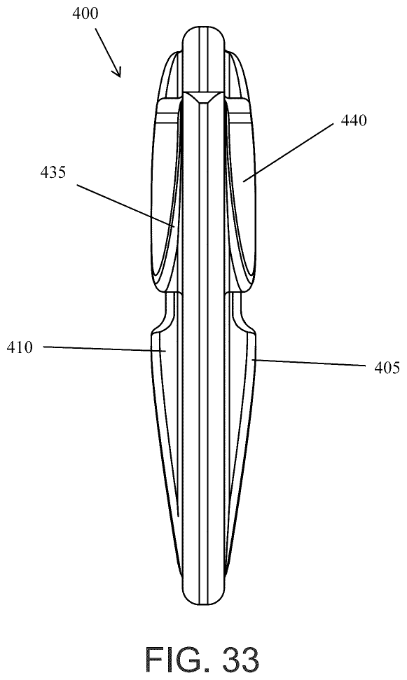

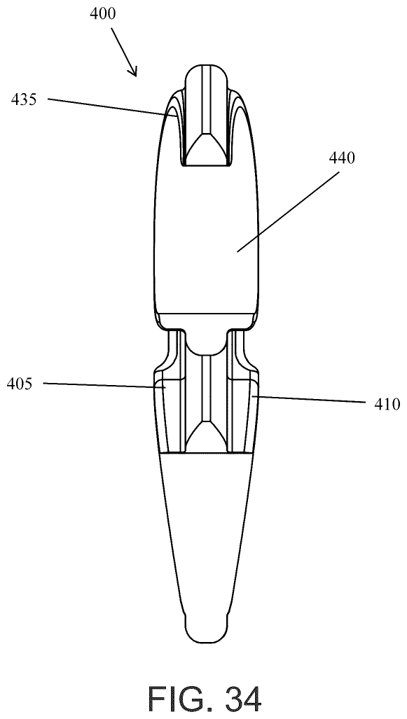

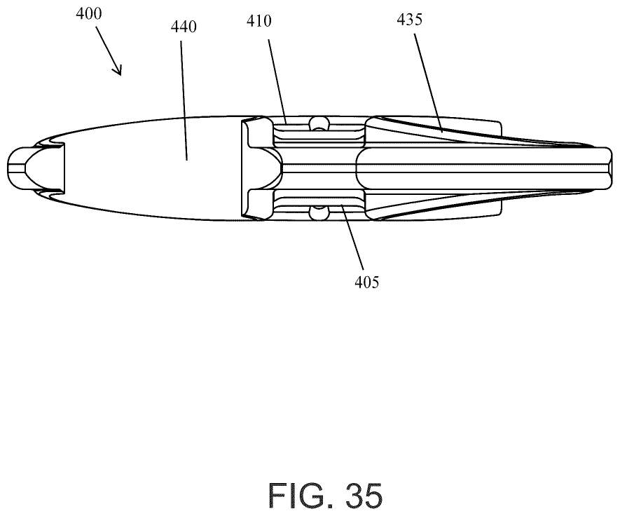

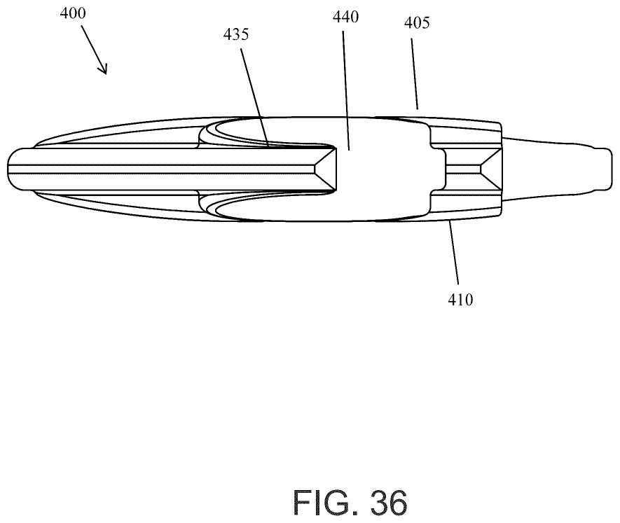

Referring to FIGS. 28-36, the pole clip device 400 includes a front surface 405 and a back surface 410 opposite the front surface 405. The pole clip device 400 further comprises a centralized hub 415. The pole clip device 400 includes a first lobe 419, a second lobe 420, and a third lobe 421 each lobe comprising a proximal end 425 coupled to the centralized hub 415. To ensure clarity when describing directions, a coordinate system is introduced wherein the z-axis will be hereafter referred to as the axial axis, centered at the centralized hub 415 and extending perpendicularly upwards from the front surface 405, and multiple radial axis defined as any direction perpendicular to axial axis and extending outwards along the three lobes 419-421. A tangential direction is defined as perpendicular to the radial axis at a distal end 430 of the three lobes 419-421. The three lobes 419-421 further comprise the distal end 430 wherein two arms form an arc along a tangential direction from the centralized hub 415 on the distal end 430 of each the three lobes 419-421. One of the two arms of two adjacent lobes of the three lobes 419-421 form a semi-circle that includes an opening 440.

The first lobe 419 features two long arms 480 forming at least thirty degrees of the arc. The second lobe 420 features a long arm 480 forming at least thirty degrees of the arc and a short arm 481 forming less than thirty degrees of the arc and being shorter than the long arm 480. The third lobe 421 features two short arms 481 both forming less than thirty degrees of the arc.

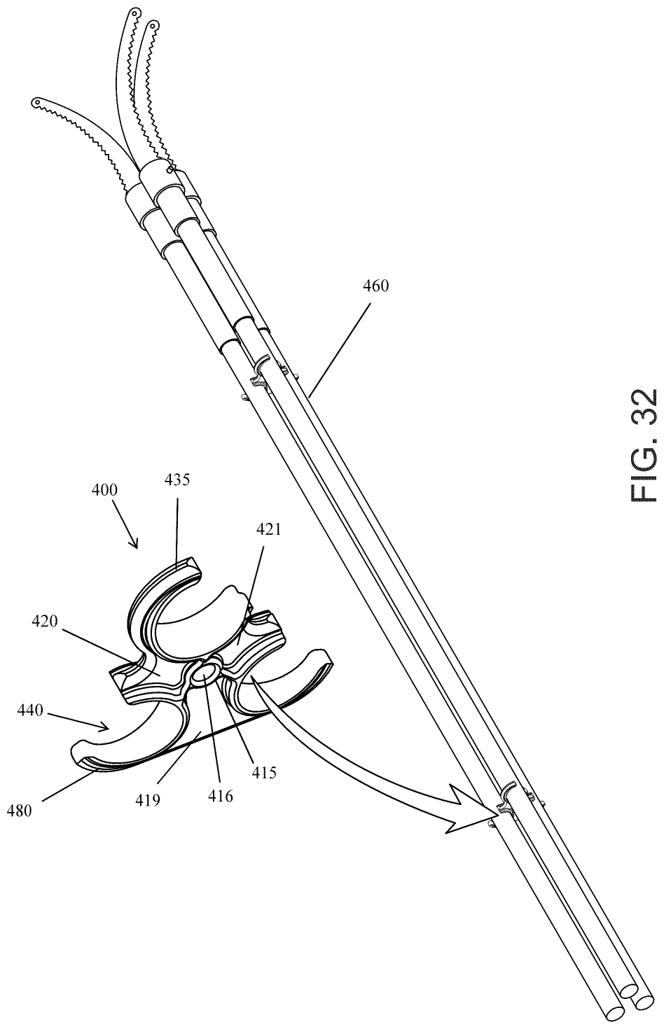

The pole clip device 400 may include a semi-flexible material and the at least one opening 440 formed by the at least one arm 435 of two adjacent lobes configured to flex during insertion of an elongated cylindrical object 460 into the opening 440 such that the opening 440 expands to conform to the shape of the elongated cylindrical object 460. Non-limiting examples of a semi-flexible material are: rubber, aluminum, and most plastics. An example of the process of inserting the elongated cylindrical object 460 into the pole clip device 400 is illustrated in FIG. 32. In this example, the elongated cylindrical object 460 is a pruning tool but the pole clip device 400 could also be other cylindrical shaped objects such as brooms, mops, rakes, etc. The opening 440 can be sized and shaped or otherwise configured to fit various other elongated objects whether such objects are fully cylindrical, semi-cylindrical, or otherwise sized and shaped to fit within the opening 440.

The opening 440 of the semi-circle formed by the adjacent lobes (e.g., such as lobe 419 and 420 of FIG. 28) is smaller relative to the diameter of the semi-circle. The opening 440 of the semi-circle may feature a latch mechanism (e.g., such as a bolt latch, a spring latch, and/or a swinging latch) configured to secure an elongated cylindrical object 460.

The pole clip device 400 can also include finishing features to improve performance and aesthetic aspects of the device. Specifically, the centralized hub 415 can have a centralized hub opening 416.

The embodiments presented all ease the maneuvering and transportation of long cylindrical objects, but each embodiment offers a unique advantage from their structure. The pole clip device 100 has a structure such that stacking piles of a clipped set of long cylindrical object would be easier over the other presented embodiments. Specifically, the three-lobe embodiment of the pole device 100 leaves enough room between the arms of one lobe for a long cylindrical object of another clipped set of cylindrical objects to rest in. This structure could be helpful when multiple sets of long cylindrical objects are needed. The pole clip device 200 offers a similar advantage in that the four-lobe structure gives the pole clip device 200 a square structure. The square structure allows the clipped set of long cylindrical objects to be placed on a flat surface with ease. For example, if many long cylindrical objects were going to transported on a flatbed vehicle, then the square structure of the pole clip device 200 would allow the clipped set of cylindrical objects to lay more securely on the vehicle's flatbed than other embodiments presented.

The pole clip device 300 provides an ergonomic structure that would be especially important when transporting a clipped set of long cylindrical objects by hand. For example, a landscaper who needs to carry tools from the work truck to the work site. The shape of the distal end 330 is smooth and fits well into the palm of a hand or under an arm.

The pole clip device 400 has a flat distal end 430 of the first lobe 419. This flat distal end 430 makes this embodiment ideal for resting on a flat surface and when compounded with the triangular structure of the clipped set, makes the embodiment great for storing many long cylindrical objects. This is accomplished by laying two clipped sets of long cylindrical objects on a flat surface side by side with the flat distal end 430 laying on the flat surface and then adding a third clipped set in between the two clipped sets with the flat surface point upwards. This creates another flat surface for the process to be repeated. This could allow for ease of storage for a large number of long cylindrical objects.

Particular embodiments and features have been described with reference to the drawings. It is to be understood that these descriptions are not limited to any single embodiment or any particular set of features, and that similar embodiments and features may arise, or modifications and additions may be made without departing from the scope of these descriptions and the spirit of the appended claims.

What is claimed is:

1. A pole clip device comprising:
a front surface;
a back surface opposite the front surface;
a centralized hub;
at least two lobes radially extending outwards from the centralized hub;
each lobe of the at least two lobes comprising:
a proximal end coupled to the centralized hub;
a distal end, opposite the proximal end, that comprises at least one arm extending therefrom;
wherein the at least one arm forms an arc along a tangential direction from the centralized hub on the distal end of each lobe of the at least two lobes;
wherein the at least one arm of two adjacent lobes of the at least two lobes form a semi-circle that includes an opening; and
wherein the opening radially opens outward from the centralized hub;
a front structural support material positioned along an outer edge of the front surface of each the at least two lobes; and
a back structural support material positioned along an outer edge of the back surface of each the at least two lobes.

2. The pole clip device of claim 1, wherein the at least two lobes each have at least one opening configured to reduce the weight of the pole clip device.

3. The pole clip device of claim 2, wherein the pole clip device includes a semi-flexible material and the at least one opening is configured to flex during insertion of an elongated cylindrical object into the opening such that the opening expands to conform to the shape of the elongated cylindrical object.

4. The pole clip device of claim 1, wherein the front structural support material and the back structural support material has a varying thickness along the axial direction of the centralized hub.

5. The pole clip device of claim 4, wherein the varying thickness of the structural support material is largest at the proximal end of each the at least two lobes and smallest at the distal end of each the at least two lobes.

6. The pole clip device of claim 1, wherein the opening of the semi-circle formed by the adjacent lobes is smaller relative to the diameter of the semi-circle.

7. The pole clip device of claim 1, wherein the opening of the semi-circle has a latch configured to secure at least one elongated cylindrical object.

8. The pole clip device of claim 1, wherein an edge of the distal end of the at least two lobes are chamfered.

9. The pole clip device of claim 1, wherein the centralized hub has a centralized hub opening.

10. A pole clip device comprising:
a front surface;
a back surface opposite the front surface;
a centralized hub;
at least two lobes radially extending outwards from the centralized hub;
each lobe of the at least two lobes comprising:
a proximal end coupled to the centralized hub;
a distal end, opposite the proximal end, that comprises at least one arm extending therefrom;
wherein the at least one arm forms an arc along a tangential direction from the centralized hub on the distal end of each the at least two lobes;
wherein the at least one arm of two adjacent lobes form a semi-circle that includes an opening;
wherein the opening radially opens outward from the centralized hub; and
a recessed channel located at the distal end of each lobe of the at least two lobes.

11. The pole clip device of claim 10, wherein the pole clip device includes a semi-flexible material and the at least one opening is configured to flex during insertion of an elongated cylindrical object into the opening such that the opening expands to conform to the shape of the elongated cylindrical object.

12. The pole clip device of claim 10, wherein the centralized hub has a centralized hub opening.

13. The pole clip device of claim 10, wherein the opening of the semi-circle formed by the adjacent lobes is smaller relative to the diameter of the semi-circle.

14. The pole clip device of claim 10, wherein the opening of the semi-circle has a latch configured to secure at least one elongated cylindrical object.

15. The pole clip device of claim 10, wherein the centralized hub has a smaller thickness than the at least two lobes.

16. A pole clip device comprising:
a front surface;
a back surface opposite the front surface;
a centralized hub;
three lobes radially extending outwards from the centralized hub;
each lobe of the three lobes comprising:
a proximal end coupled to the centralized hub;
a distal end, opposite the proximal end, that comprises two arms extending therefrom;
wherein the two arms form an arc along a tangential direction from the centralized hub on the distal end of each the three lobes;
wherein arms of two adjacent lobes form a semi-circle that includes an opening;
the three lobes comprising:
a first lobe comprising:
two long arms forming at least 30 degrees of the arc;
a second lobe comprising:
a long arm forming at least 30 degrees of the arc;
a short arm forming less than 30 degrees of the arc and being shorter than the long arm; and
a third lobe comprising:
two short arms forming less than 30 degrees of the arc.

17. The pole clip device of claim 16, wherein the pole clip device includes a semi-flexible material and the at least one opening is configured to flex during insertion of an elongated cylindrical object into the opening such that the opening expands to conform to the shape of the elongated cylindrical object.

18. The pole clip device of claim 16, wherein the opening of the semi-circle formed by the adjacent lobes has a width that is smaller relative to the diameter of the semi-circle.

19. The pole clip device of claim 16, wherein the opening of the semi-circle has a latch configured to secure at least one elongated cylindrical object.

20. The pole clip device of claim 16, wherein the centralized hub has a centralized hub opening.
